(19) United States
(12) Patent Application Publication
(10) Pub. No.: US 2009/0296006 A1
(43) Pub. Date: Dec. 3, 2009

(54) VEHICLE MEDIA DEVICE

(75) Inventors: Douglas C. Campbell, Northville, MI (US); David B. Busch, Holland, MI (US); Jonathan A. Dykstra, Holland, MI (US); Steven G. Schultz, Holland, MI (US)

Correspondence Address: FOLEY AND LARDNER LLP;SUITE 500, 3000 K STREET NW, WASHINGTON, DC, 20007, US

(73) Assignee: Johnson Controls Technology Company

(21) Appl. No.: 12/481,442

(22) Filed: Jun. 9, 2009

Related U.S. Application Data
(63) Continuation of application No. 11/640,433, filed on Dec. 15, 2006.
(60) Provisional application No. 60/752,983, filed on Dec. 22, 2005.

(51) Int. Cl. H04N 5/64

(52) U.S. Cl. 348/837; 348/E05.128

(57) ABSTRACT

A media device door for a vehicle has a door configured to be coupled to a vehicle part. The door has an interior side facing the vehicle part and an exterior side facing a vehicle passenger compartment. The door has an open position and a closed position. A media device is incorporated into the door and remains operational regardless of the door position. A control for the media device is hidden behind the door when the door is in the closed position.

### CROSS-REFERENCE TO RELATED PATENT APPLICATIONS

This application is a continuation of U.S. application Ser. No. 11/640,433, filed Dec. 15, 2006, incorporated herein by reference in its entirety, which claims priority from U.S. provisional application 60/752,983, filed Dec. 22, 2005, incorporated herein by reference in its entirety.

### BACKGROUND

The present invention relates to a vehicle media device. In particular, the present invention relates to a media device incorporated into a movable door that may be located at various positions within a vehicle. The controls for the media device may be located on the exterior or interior side of the door or on a part of the vehicle itself.

Conventional media devices such as CD players and DVD players may be located in the center stack area of the instrument panel of a vehicle. A conventional approach is to install a media device into a corresponding recess in the instrument panel that may be configured to accept different media devices depending on the type of vehicle being manufactured.

The controls for conventional media devices are typically located on the device itself, such as the buttons used to operate a CD player. Alternatively, controls have been mounted elsewhere in the vehicle to provide convenient access for the vehicle occupants. As media devices have become more sophisticated, the number of controls for the media devices have increased, adding clutter to the instrument panel, in particular the center stack area.

The number of media devices that consumers wish to have in vehicles is increasing. New media devices may include data storage such as a memory stick or secure digital card for use with digital music players or other digital devices, various phones, computer or video screens, personal digital assistant cradles, and vehicle navigation systems, in addition to the already common devices such as CD and DVD players.

The installation of multiple media devices in conventional locations in the instrument panel, such as in the center stack, may add to a cluttered appearance of the instrument panel. Further, it may be difficult for a manufacturer or end user to easily change the configuration of such devices (such as by installing different types of devices) because conventional recesses used to house such devices in the instrument panel are already in place and may be configured to receive a small subset of media devices. It would be advantageous to provide an easier way to change media devices in a vehicle without reconfiguring the instrument panel, and without changing the overall appearance of the instrument panel or other trim in the vehicle.

Trim panels in a vehicle, whether on the instrument panel, in doors, or in a headliner are designed so as to have a pleasing aesthetic appearance to the end customer. Accordingly, there is a need for a media device configured to not disrupt the trim panels provided in a vehicle, and that may be interchanged with another media device without changing the appearance of the trim panels. To the extent that the same trim panels may be used with different media devices, a vehicle may require fewer custom parts to support the additional features.

Media devices, especially those with moving parts such as a DVD player, may utilize valuable space on an instrument panel or in the center stack of a vehicle. There is a need for an ability to configure such a media device to permit use of the space within the instrument panel or center stack behind the desired location of the media device.

The location of controls for media devices within a vehicle is a design consideration. While conventional devices typically have the controls placed on the device itself, there is a need for other design options, such as a design intended to protect controls from contamination and breakage.

There is a need for media devices that may be conveniently placed in a number of locations in a vehicle by a vehicle manufacturer without substantial redesign of the vehicle interior. For example, it may be desirable to place a DVD player in a position accessible to passengers of the vehicle, such as in the rear of a vehicle seat, in a vehicle door, or in a vehicle headliner. However, conventional media devices are typically configured to fit into a recess in the instrument panel. A similarly sized recess may not be available in the rear side of a vehicle seat back to permit the relocation of a media device into that position.

Although there is a need for the ability to place controls for a media device in alternate locations, such as behind a door, it would also be desirable to insure that any media device maintains its functionality when the hidden controls are being accessed.

The decorative trim portions of an instrument panel or other parts of a vehicle are expensive to design and manufacture. Accordingly, there is a need for a media device configuration that permits the exchange of one media device for another while still permitting the use of the same trim part.

It would be desirable to provide a system and/or method that provides one or more of these or other advantageous features. Other features and advantages will be made apparent from the present specification. The teachings disclosed extend to those embodiments that fall within the scope of the appended claims, regardless of whether they accomplish one or more of the aforementioned needs.

### SUMMARY

One aspect of the invention relates to a media device door for a vehicle. The media device door for a vehicle includes a door configured to be coupled to a vehicle part, the door having an interior side facing the vehicle part and an exterior side facing a vehicle passenger compartment. The door has an open position and a closed position. A media device is incorporated into the door and remains operational regardless of door position. A first control for the media device is hidden behind the door when the door is in the closed position.

Another aspect of the invention relates to an instrument panel system for a vehicle. The instrument panel system includes an instrument panel and a media device door coupled to the instrument panel. The door has an interior side facing the instrument panel and an exterior side facing a vehicle passenger compartment and has an open position and a closed position. A media device is coupled to the door and moves along with the door and remains operational regardless of door position. A first control for the media device is hidden behind the media device door when the media device door is in the closed position.

The invention is capable of other embodiments and of being practiced or being carried out in various ways. Alternative exemplary embodiments relate to other features and combinations of features as may be generally recited in the claims.

### BRIEF DESCRIPTION OF THE DRAWINGS

The invention will become more fully understood from the following detailed description, taken in conjunction with the accompanying drawings, wherein like reference numerals refer to like elements, in which:

FIG. 1 is an elevation view of an instrument panel of a vehicle;

FIG. 2 is a perspective view of an instrument panel of a vehicle;

FIG. 3 is a side elevation view of a media device door in an open position;

FIG. 4 is a side elevation view of a media device door in an open position;

FIG. 5 is a side elevation view of a vehicle seat having a media device door;

FIG. 6 is a side elevation view of a vehicle door having a media device door; and

FIG. 7 is an elevation view of a vehicle interior with a media device door in a headliner.

FIG. 8 is a side elevation view of a media device and a media device door in an open position.

FIG. 9 is a side elevation view of a media device and a media device door in a closed position.

FIGS. 10A-10C are perspective views of a vehicle component having a media device and a media device door with controls according to exemplary embodiments.

### DETAILED DESCRIPTION

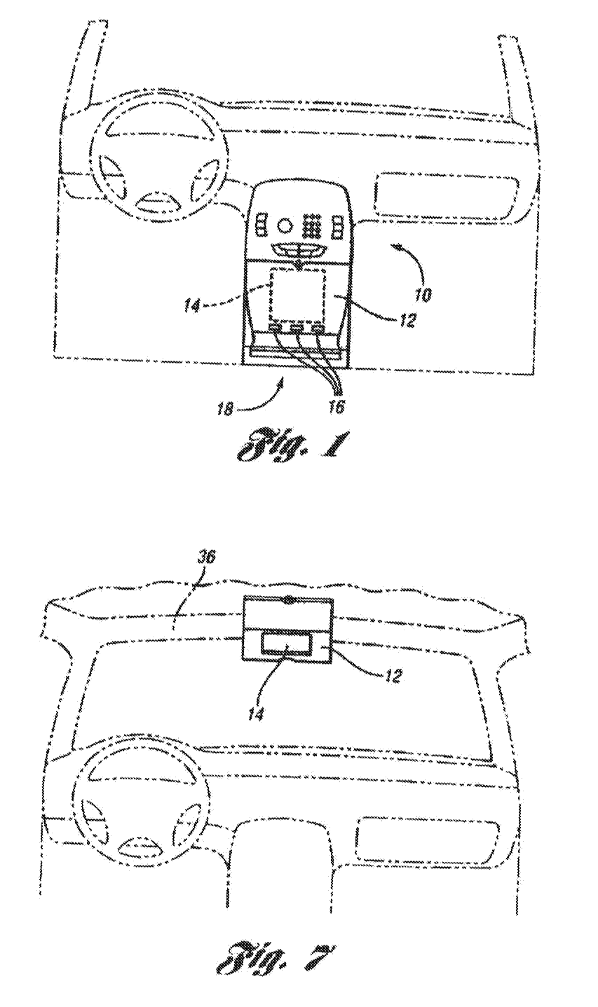

Referring to FIG. 1, in a vehicle such as an automobile, sport utility vehicle, or truck, there is typically an instrument panel 10 that houses various instruments and controls. In one embodiment of the invention, a media device door 12 is coupled to the instrument panel 10. The media device door 12 may be coupled to the instrument panel 10 in a variety of ways known in the art, such as by a hinge permitting pivotal movement or by another system permitting translational movement. Accordingly, the media device door 12 may be opened and closed similarly to other compartment doors located in a vehicle (see FIG. 6).

Further referring to FIGS. 1 and 2, a media device 14 may be physically coupled to the media device door 12 such that the media device 14 opens and closes with the media device door 12. The media device 14 is shown schematically in the Figures, and could comprise any number of media devices used in vehicles such as a CD or DVD player, a memory storage device such as a memory stick or secure digital card, a phone, a video display screen, a personal digital assistant cradle, or other types of media devices known in the art or designed in the future.

The media device 14 may be coupled to the media device door 12 in a variety of ways. For example, the media device may be held within a pocket within the media device door, attached via hardware to the interior side of the media device door, or substantially comprise the media device door. Alternatively, the media device may be attached to the media device door by a hook and loop fastener system. The media device may be visible from the exterior side of media device door 12, but it is envisioned that in a preferred embodiment, the media device 14 is not visible from the exterior side of media device door 12, thus simplifying the overall look of the instrument panel 10.

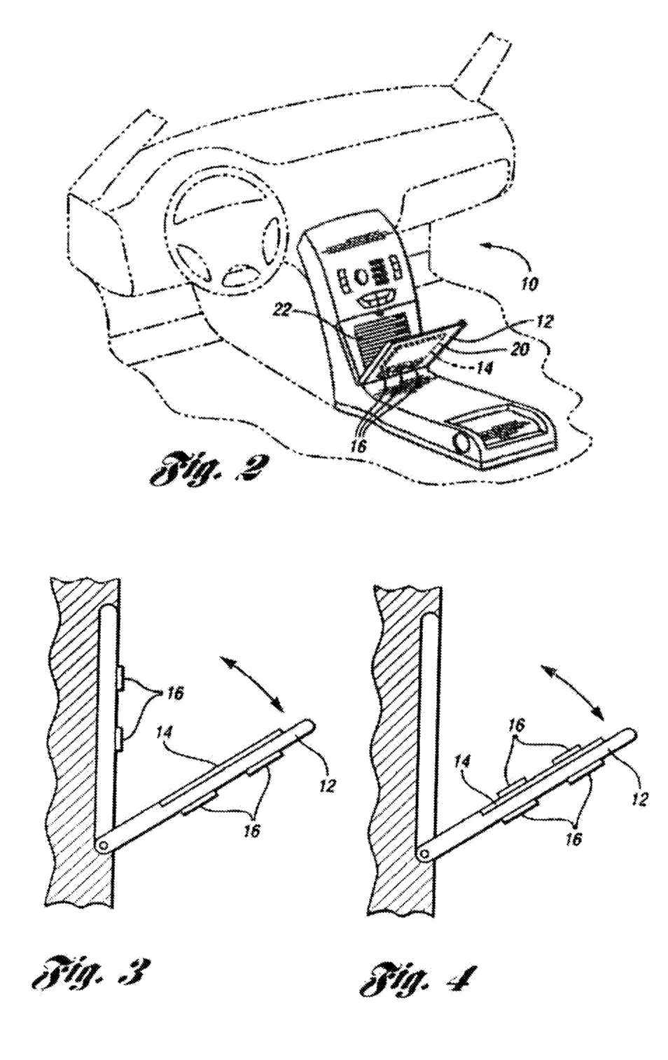

Referring to FIGS. 1-4, media devices 14 typically have a number of controls 16 used to control operation of the media device 14. Such controls 16 may include play-back controls for a CD player or DVD player, dialing controls for a phone, navigation controls for a navigation system, or computer controls for other types of computer equipment. Even relatively simple media devices 14 may have a large number of controls 16. The controls may be placed directly on the exterior of the media device, but may also be placed in other locations on instrument panel 10 or on the exterior of the media device door 12, separated from media device 14 (see FIGS. 3 and 4). However, in a preferred embodiment, controls 16 are placed on the interior side of media device door 12 (see FIG. 4) so that the controls 16 are hidden when media device door 12 is closed. In another exemplary embodiment, controls 16 are located on the instrument panel or other vehicle part and are also hidden when media device door 12 is closed (see FIG. 3).

In the exemplary embodiment depicted in FIG. 1, media device door 12 having media device 14 is located in the center stack 18 area of instrument panel 10. Depending on the size of media device 14, as well as other design considerations, media device door 12 may be of various sizes and design styles.

The inclusion of media device 14 in media device door 12 opens additional space behind the media device door 12 in instrument panel 10 for other functional considerations. For example, as depicted in FIG. 2, a storage space, shown as storage rack 22, may be included behind the media device door 12, such as for the storage of CDs and the like. Other items that may be located behind media device door 12 could include the inclusion of a secure area or other electronic components.

In an exemplary embodiment, media device 14 remains functional regardless of the position of media device door 12. For example, a DVD player may be in operation and remain in operation while a vehicle occupant opens media device door 12 to access objects located in recess 22, or to access controls 16 disposed on the interior side of media device door 12 or behind media device door 12 on instrument panel 10.

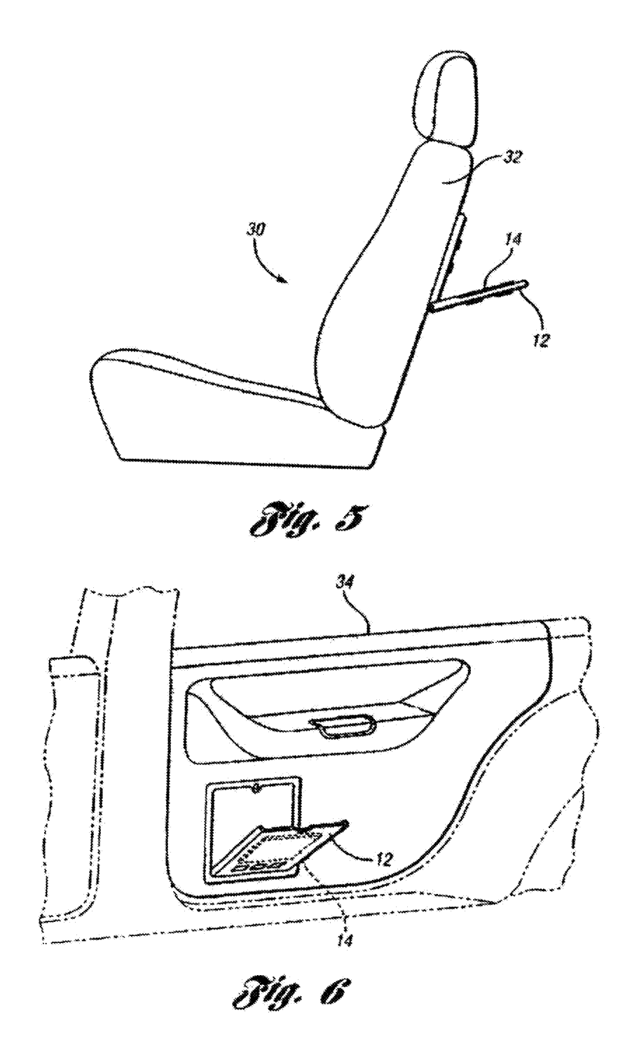

Referring to FIGS. 5-7, the media device door 12 and incorporated media device 14 may be located at various positions throughout a vehicle. For example, as depicted in FIG. 5, the media device door 12 may be located on the rear side of a vehicle seat 30, in particular, incorporated into a seatback 32. While a conventional automobile seatback 32 may not be sized or easily reconfigured to house a conventional media device 14 and associated housing, the media device door 12 of the present invention provides a solution via the incorporation of media device 14, thus presenting the opportunity to add a media device 14 to a vehicle seatback 32 without substantial redesign of the seatback 32.

Referring to FIG. 6, in another exemplary embodiment, media device door 12 may be located in a vehicle door, such as rear door 34 to permit access to media device 14 by rear seat passengers of the vehicle. Referring to FIG. 7, in a further embodiment, the media device door 12 and media device 14 may be located in the headliner 36 of a vehicle at various locations depending on the desired configuration of the vehicle. According to an alternative embodiment, the media device door and media device may be located in a center console (such as in a back of a center console facing rear seat passengers.

Referring to FIG. 1, a trim panel 20 may cover the exterior side of media device door 12. The style of trim panel 20 may be designed to match the particular location within vehicle at which media device door 12 is installed. The media device door 12 may include any of a variety of types of media devices 14 without reconfiguration, thus permitting the same trim panel 20 to be used. Media device aesthetics may, for example, be designed to match or contrast the color scheme of the vehicle interior. This concept is intended to enhance the overall aesthetic appearance of the interior of the vehicle and permits different options to be chosen by a customer (e.g. the original equipment manufacturer or the end consumer) with respect to the number, types, and locations of media devices 14 within the vehicle without requiring redesign of the interior style (such as by changing trim panels). Alternatively, the door and trim panel may be chosen in any of a wide variety of colors, materials and textures to compliment, contrast and/or coordinate with a design scheme or appearance of the vehicle interior. The trim panel may be attached to the media device door in any conventional manner such as by an adhesive or a hook and loop fastener system.

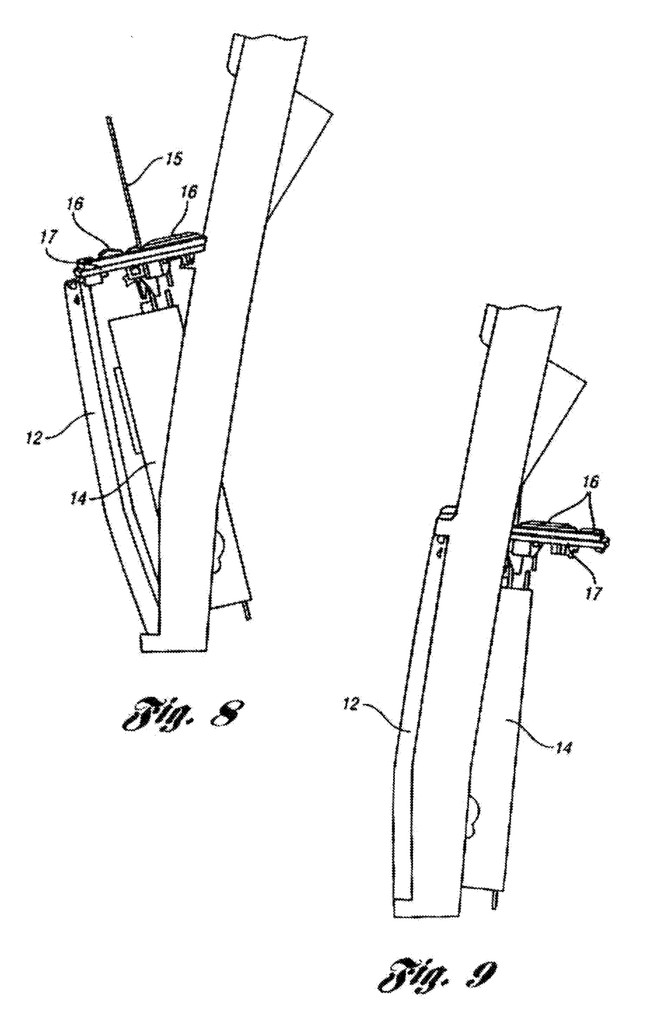

Referring to FIGS. 8-9, a media device 14 may be coupled (e.g. mounted, etc.) to a generally vertical media device door 12 that is movable between an open position (see FIG. 8) for accessing the media device (shown for example as a CD or DVD player with a CD or DVD 15) and/or controls 16 located on an inside area of the door 12 (shown for example as located on a top panel 17), and a closed position (see FIG. 9) where other controls (such as frequently-used controls) are accessible on an outside or exterior of the door 12. The controls 16 may be provided in any suitable form, such as push-buttons, knobs, dials, sliders, displays (e.g. LED, LCD, etc.), and designed to control operation of the media device, or other desirable features within a vehicle interior environment (such as but not limited to lighting, HVAC, sun/moon roof operation, etc.). Moreover, the media device 14 may be any known media device within the art including a CD player, CD-ROM, DVD player, flash memory reader (e.g., for USB or security digital memory devices), MP3 player, MP4 player and so forth.

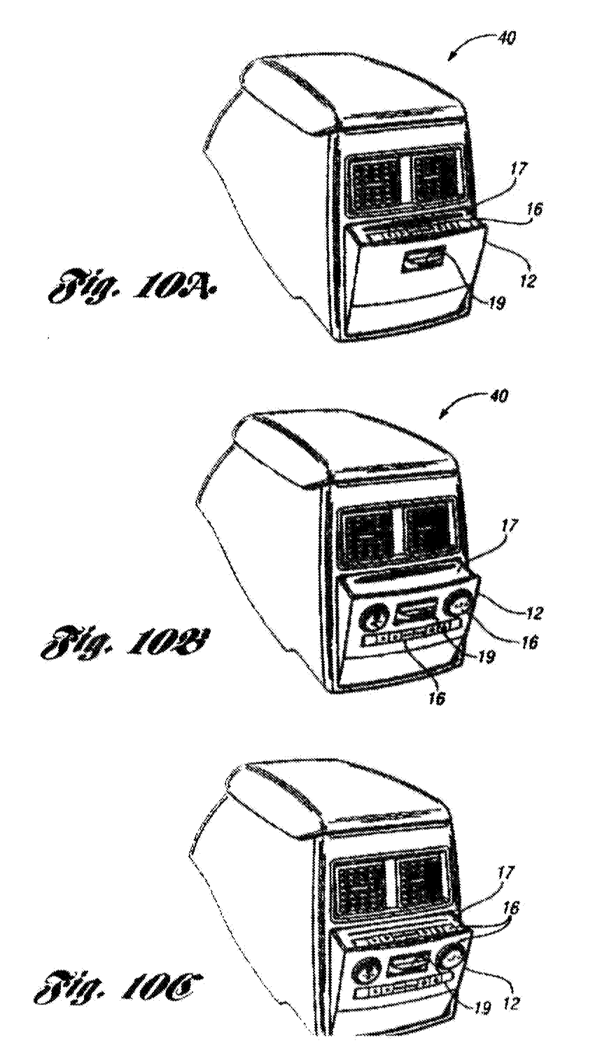

The door 12 is configured to move to the open position when access to the media device 14 is desired (such as to change a CD, DVD, etc.) or access interior controls. The door is also movable to the closed position after accessing the media device so that the media device may remain unobtrusively stored or concealed within a panel or other suitable component in the vehicle (e.g. door panel, instrument panel, seat back, a console (as shown for example in FIGS. 10A-10C), center stack, etc.) such as for rear seat entertainment systems or other suitable application. The door 12 is provided with a material, texture and finish that is intended to match or otherwise compliment, coordinate, or contrast with (or otherwise aesthetically enhance) the trim and finish of the associated vehicle component.

According to a preferred embodiment, the top panel 17 is shown connected to a top edge of the door 12 and is intended to “trim-out” the opening for the door when the door is moved to the open position, and to conceal the media device beneath the panel, and to provide sufficient clearance for the internal controls (shown for example as mounted on the top panel) to pivot with the door for access by a user. According to an alternative embodiments, a separate top panel may be omitted, and the media device may be positioned with its own “face” (having the internal controls thereon) positioned adjacent to the top edge of the door so that the face panel of the media device acts as its own “top panel” and internal controls on the face of the media device are “revealed” and made accessible to a user when the door is moved to the open position, and then “concealed” when the door is moved to the closed position.

According to one embodiment, the door 12 may be arranged to open and closed manually by a user, and may be provided with a suitable spring-damper device (not shown—which may be located at the pivoting hinge at the base of the door) that tends to bias or move the door toward a desired position (such as the open position) when a suitable release mechanism 19 (such as a catch or a latch—shown for example in FIGS. 10A-10C) for the door is activated by the user. Alternatively, the door (and media device attached thereto) may be “automatically” operated between the open and closed positions using suitable control device and mechanism (such as a motor and linear or rotational actuator) that is selectively activated by a user (such as by an “open/close” button or interface). According to another embodiment, an operational interlock may be provided to prevent the door from moving to the closed position if a CD or DVD is in an ejected or extended position (as shown for example in FIG. 8). In addition, suitable controls may be provided to automatically open the door if a user activates an external control 16 that would result in ejecting a CD or DVD when the door is in the closed position.

Referring to FIGS. 10A-10C, the media device is shown for example as installed in a rear panel of a center console 40 and having controls arranged according to various exemplary embodiments. For example, the controls 16 are shown in FIG. 10A to include “internal” controls (shown for example as pushbutton controls) positioned on the top panel 17. By further way of example, the controls 16 are shown in FIG. 10B to include “external” controls 16 (shown on an exterior surface of door 12 as pushbutton controls and dial or knob type controls). By further way of example, the controls 16 are shown in FIG. 10C to include “internal” controls 16 (shown on the top panel 17 as pushbutton controls) and “external” controls 16 (shown on an exterior surface of door 12 as pushbutton controls and dial or knob type controls).

According to any preferred embodiment, the vehicle media device is intended to provide a revealable and concealable system for housing a media device in a vehicle component, and provide a desirable combination of interior and exterior controls for the media device and other vehicle interior features, that minimizes package space, and provides a clean appearance, and is coordinated with the trim and decor of the vehicle, and is easily and conveniently operated by a user. The door may include a display panel and/or audio speakers operably associated with the media device for displaying images and/or broadcasting sound from the media device. Alternatively, a display panel and/or audio speakers may be located remotely from the door, yet operated by controls 16 (internal and/or external).

According to any preferred embodiment, the vehicle media device is operable when removed from the media door such that media device is portable. Media device includes its own auxiliary power supply for operation when in portable mode. Moreover, media device may include a second control panel and audio/video system for operation while in portable mode. For example, media device may include speakers or headphones and a stowable screen. Electronic connectors are included on the body of the media device to selectively couple the media device to the vehicle power bus and/or audio/video system. Such audio/video connectors may include, e.g., DisplayPort, RF connectors, VDL, banana connectors, DIN connectors, RCA connectors. Electrical connectors may also include receptacles, jacks, plugs, ports, electrical connecting strips and so forth. In one embodiment, the media device is configured to wirelessly communicate with the vehicle's audio/video system. Bluetooth technology, configured to enable short-range communication between electronic devices is utilized to enable the video source 14 to communicate with the display 48 wirelessly. Other wireless standards or technologies are compatible with the vehicle vision system 10 such as IEEE 802.11 and other communication platforms.

The media device door 12 is also intended to protect the media device and associated internal controls from damage and contamination, especially in an exemplary embodiment wherein the media device 14 and controls 16 are located on the interior side of the door 12 (FIG. 4) or are covered by media device door 12 when closed (FIG. 3). In an exemplary embodiment, the controls placed on the interior side of media device door are those controls that are infrequently used, thus reducing the number of controls permanently visible on instrument panel or other locations within a vehicle, aiding in the overall appearance of the interior of the vehicle.

While the detailed drawings and specific examples given describe various exemplary embodiments, they serve the purpose of illustration only. It is to be understood that the invention is not limited in its application to the details of construction and the arrangements of components set forth in the preceding description or illustrated in the drawings. For example, while the media device door is typically shown having a pivotal attachment to a vehicle part, the media device door may be attached to permit translational movement of the media device door between the opened and closed positions. Additionally, although the media device is shown as incorporated into the media device door, the media device may be disposed in a position separate from the door, but covered by the door when the door is in a closed position. Furthermore, other substitutions, modifications, changes, and omissions may be made in the design, operating conditions, and arrangements of the exemplary embodiments without departing from the scope of the invention as expressed in the appended claims.

What is claimed is:

1. A media system for mounting in a vehicle having at least one of a vehicle audio system and a vehicle video system and for use with a portable media device, comprising:
a door configured to be coupled to the vehicle and to have an open position and a closed position when coupled to the vehicle, wherein the door further comprises an interior side and an exterior side configured to face a vehicle passenger compartment when the door is in the closed position, wherein the door is configured to receive and mechanically hold a portable media device;
a connector configured to communicate with the portable media device; and
first controls on the door and configured to control the portable media device via the connector when the portable media device is communicating with the connector.

2. The media system of claim 1, wherein the connector is configured to provide data from the portable media device to the at least one of a vehicle audio system and vehicle video system.

3. The media system of claim 2, wherein the connector is configured to electrically couple to the portable media device using at least one of a DisplayPort connector, a VDL connector, a banana connector, a DIN connector, and an RCA connector.

4. The media system of claim 2, wherein the connector is a wireless transceiver.

5. The media system of claim 4, wherein the wireless transceiver is configured for operation with at least one of a Bluetooth protocol and an IEEE 802.11 wireless communication protocol.

6. The media system of claim 1, wherein the first controls are located on the exterior side of the door.

7. The media system of claim 1, wherein the first controls are located on the interior side of the door.

8. The media system of claim 7, wherein second controls are located on the exterior side of the door.

9. The media system of claim 1, wherein the portable media device comprises second controls for controlling playback of data stored on the portable media device.

10. The media system of claim 1, further comprising a trim panel coupled to the exterior side of the door, wherein the door is configured to permit the portable media device to be removed from the door and to permit the installation of a second portable media device in the door without changing the trim panel.

11. The media system of claim 1, wherein the door is configured to pivotally couple to the vehicle.

12. The media system of claim 1, wherein the portable media device comprises at least one of a memory storage device, an MP3 player, an MP4 player, and a phone.

13. The media system of claim 1, wherein the portable media device comprises at least one of a USB device, a secure digital media device, a personal digital assistant, and a navigation system.

14. The media system of claim 1, wherein the connector comprises at least one of a memory reader, a USB port, an MP3 player interface, an MP4 player interface, a phone interface, a personal digital assistant cradle, and a navigation system interface.

15. The media system of claim 1, further comprising:
a compartment located behind the door and facing the interior side of the door when the door is in the closed position, the compartment configured to stow the portable media device when the door is in the closed position.

16. The media system of claim 1, wherein the door comprises a pocket for holding the portable media device.

17. The media system of claim 1, wherein the door comprises hardware for attaching the portable media device to the door.

18. The media system of claim 1, wherein the door comprises a hook and loop fastener system for attaching the portable media device to the door.

19. The media system of claim 1, wherein the connector is further configured to connect the portable media device to a vehicle power bus.

20. A media system for mounting in a vehicle having at least one of a vehicle audio system and a vehicle video system and for use with a portable media device configured to be operated with and independently of the media system, comprising:
a door configured to be pivotally coupled to the vehicle and having an open position and a closed position, the door having an interior side and an exterior side facing a vehicle passenger compartment when the door is in the closed position, the door configured to receive and mechanically hold a portable media device to at least one of the interior side of the door and within the door, wherein the door is configured to mechanically hold the portable media device using at least one of hardware and a pocket for holding the portable media device;
a connector configured to communicate with the portable media device and to provide data from the portable media device to the at least one of a vehicle audio system and a vehicle video system using at least one of a wired communication link and a wireless communication link, the connector further configured to connect the portable media device to a vehicle power bus;
first controls on the exterior side of the door and configured to control the portable media device via the connector when the door is closed and when the portable media device is received by the door and is communicating with the connector; and
a trim panel coupled to the exterior side of the door, wherein the door is configured to allow the portable media device to be removed from the door and to allow a second portable media device to be received and mechanically held to at least one of the interior side of the door and within the door, wherein the door is configured to mechanically hold the portable media device using at least one of hardware for attaching to the portable media device and a pocket for holding the portable media device;
wherein the portable media device comprises at least one of an MP3 player, an MP4, a phone, and a personal digital assistant, and wherein the portable media device comprises second controls configured to control playback of data stored on the portable media device when the portable media device is removed from the door.
